(19) United States
(12) Patent Application Publication
(10) Pub. No.: US 2009/0064228 A1
(43) Pub. Date: Mar. 5, 2009

(54) Method for Defining Virtual Channels in Interactive Program Guide and User Interface Thereof

(75) Inventor: Chi Chia Lin, Tainan County (TW)

Correspondence Address: WPAT, PC;INTELLECTUAL PROPERTY ATTORNEYS, 2030 MAIN STREET, SUITE 1300, IRVINE, CA, 92614, US

(73) Assignee: HIMAX TECHNOLOGIES LIMITED, Tainan County (TW)

(21) Appl. No.: 11/848,738

(22) Filed: Aug. 31, 2007

(51) Int. Cl. G06F 3/00

(52) U.S. Cl. 725/46

(57) ABSTRACT

The method for defining virtual channels in an interactive program guide includes the steps of: defining a virtual channel number and/or channel name; searching programs in the EPG which satisfy a search criterion; inserting the searched programs into the defined virtual channel; and resolving schedule conflicts with the searched programs.

### BACKGROUND OF THE INVENTION

1. Field of the Invention

The present invention relates to a method applied in an interactive program guide, and more particularly to a method for defining virtual channels in an interactive program guide and the user interface thereof.

2. Description of the Related Art

DTV is becoming more and more popular throughout the world. In a DTV environment, the program guide is transmitted in a digital manner through a variety of channels. When a user turns on a DTV, the first thing he or she looks at is inevitably an electronic program guide (EPG). Through the EPG, it is easier for the user to understand program content, and thus select the operations he or she needs, such as pre-recording, searching, scheduling and setting up personal preferences.

One common complaint regarding prior EPGs is that they are not so friendly to users. One example of this is users' difficulty in locating their desired programs. Another example is the difficulty in remembering so many channel names and corresponding channel numbers. It is commonly seen that people remember a program but do not remember the channel on which the program is broadcast. Therefore, when viewers turn on the TV, they will still spend a lot of time searching for their desired programs channel-by-channel.

Because a friendly user interface is necessary to meet user demands, it is important to design a cost-effective method to resolve such issue.

### SUMMARY OF THE INVENTION

The method for defining virtual channels in an interactive program guide in accordance with an embodiment of the present invention comprises the steps of: defining a virtual channel number and/or channel name; searching programs in the EPG which satisfy a search criterion; inserting the searched programs into the defined virtual channel; and dealing with conflicting schedules of searched programs.

The method for defining virtual channels in an interactive program guide in accordance with an embodiment of the present invention comprises the steps of: defining a virtual channel number and/or channel name; inserting desired programs in the electronic program guide into the defined virtual channel; and dealing with program conflict.

A user interface for defining virtual channels in the interactive program guide comprises a search criterion area, a program-listing area and a virtual channel. The search criterion area includes hierarchical searching items. The program-listing area lists programs of EPG which satisfy a search criterion of the search criterion area. The virtual channel collects desired programs selected from the program-listing area.

### BRIEF DESCRIPTION OF THE DRAWINGS

The invention will be described according to the appended drawings in which:

FIG. 1 shows a user interface in accordance with an embodiment of the present invention; and

FIG. 2 shows a flow chart of defining virtual channels in an interactive program guide in accordance with an embodiment of the present invention.

### PREFERRED EMBODIMENT OF THE PRESENT INVENTION

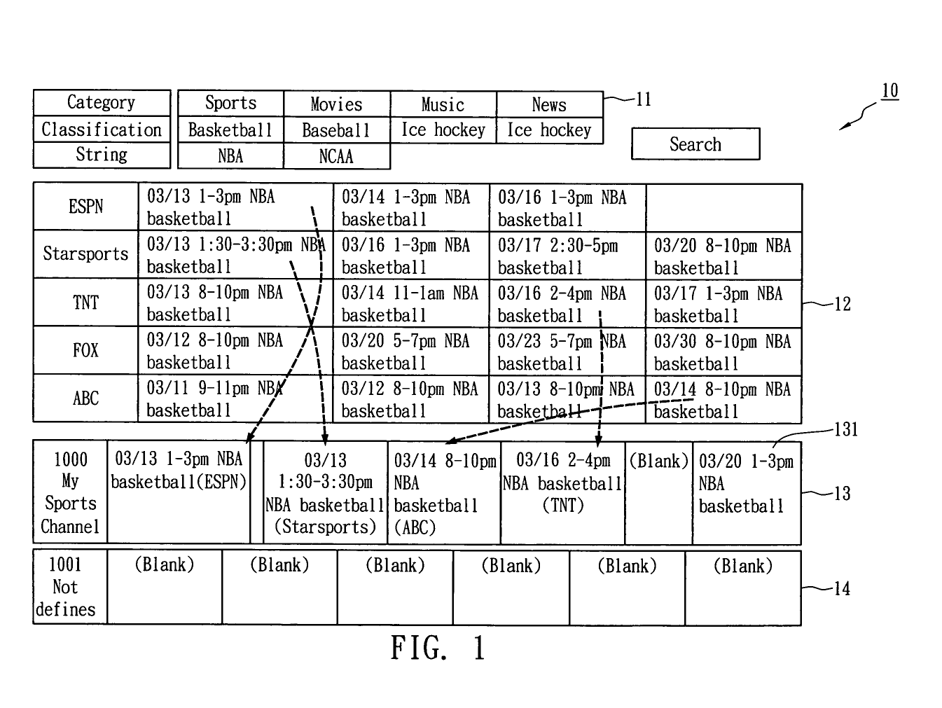

FIG. 1 shows a user interface of an interactive program guide in accordance with an embodiment of the present invention. The user interface 10 includes three parts, i.e., a search criterion area 11, a program-listing area 12 and a virtual channel 13 (or more than one virtual channel, such as the undefined virtual channel 14). The search criterion area 11 may include category field, classification field and string field, which are arranged in hierarchy. For example, the category field may include sports, movies, music, news, and so on. If the viewer chooses “sports,” then a submenu corresponding to the classification field shows baseball, basketball, ice hockey, and so on. If the viewer further chooses “basketball,” then a submenu corresponding to the string field shows NBA and NCAA. Assuming that the viewer decides to watch NBA, then he or she needs to move the cursor into “NBA” and click the “Search” button in the top right corner. Subsequently, the program-listing area 12 lists all the channels which are scheduled to broadcast NBA programs. The first column of the program-listing area 12 shows the channel name, e.g., ESPN, StarSports, TNT, Fox and ABC. The other columns show the NBA programs of each channel in a time sequence. The viewer can use the existing remote controller or scrolling bar to move the user interface down or right to see more programs if the listings are too numerous to view in a single window.

The virtual channel 13 is a user-defined channel, which is used to collect all the desired programs broadcast by other channels into a single channel. For example, the viewer can define a program of March 13, 1:00-3:00 p.m., which includes an NBA program on the ESPN channel at that time, a program of March 13, 1:30-3:30 p.m. which includes an NBA program on the StarSports channel at that time, a program of March 14, 8:00-10:00 p.m. which includes an NBA program on the ABC channel at that time, and a program of March 16, 2:00-4:00 p.m. which includes an NBA program on the TNT channel at that time. The means for defining the schedule can be done by drafting or selecting the desired programs with a mouse or remote controller, to the destination place in the virtual channel 13. To cooperate with the mouse or remote controller, there are some pointers or menu in the user interface to help the viewer to navigate the mouse or remote controller. In addition, there could be a pop-up window to help the viewer to select the source program and to arrange the schedule in the virtual channel. The present invention is not intended to be limited to any particular designation method. The virtual channel 13 encompasses some blank time slots, which can be used to broadcast default channels or display picture, short video or texts.

Sometimes the desired programs in the virtual channel 13 conflict with each other. For example, in FIG. 1 the NBA program of March 13, 1:00-3:00 p.m. conflicts with the NBA program of March 13, 1:30-3:30 p.m. One method to solve such a situation is to highlight with different colors to remind the viewer that a conflict exists. For example, the program on ESPN from 1:00-3:00 is highlighted with blue, the program on StarSports from 1:30-3:30 is highlighted with yellow, and the overlapping part from 1:30-3:00 is highlighted with green. When the viewer finds the conflict, he or she can choose to record one of the programs and view it at a later conflict-free period. If the viewer does not do anything to avoid such a conflict, when the NBA program on ESPN goes on to 1:30 pm, the user interface will pop up a warning that another pre-defined program is going to be displayed. Meanwhile, the viewer can choose to watch the current program or switch to the other pre-defined program.

The viewer can define one or more virtual channels, depending on his or her demands. Also, the user can give a channel name and/or channel number for each selected channel. For example, the channel 1000 in FIG. 1 is named as My Sports Channel; and channel 1001 is currently undefined. The viewer can also proceed to deal with program display times. It can be foreseen that the viewer probably intends to watch the program at preceding or later time. If the viewer intends to watch the program at preceding time, the present method checks whether the program is a replayed one and thus has a copy in memory. If not, the method further checks if there is any possibility to record the program before the user-defined schedule. If the answer of either of the above two is yes, then the present method goes on to do its task. Otherwise, the present method sends a message to the viewer in advance that the task is impossible to carry out. If the viewer intends to watch the program at a later time, the present method checks whether the system resources, e.g., the number of recorders, tuners and memory, are enough to pre-record the program. If the answer is yes, then the present method goes on to do its task. For example, in FIG. 1 the program 131 in the virtual channel 13 may come from the NBA program of March 17, 1:00-3:00 p.m. on the TNT channel. Otherwise, the present method sends a message to the viewer in advance that the task is impossible to carry out.

The programs in the virtual channel 13 are not limited to be selected from the program-listing area 12. If the viewer finds a favorite program in the EPG, he or she can directly put that favorite program in the virtual channel 13. The search criterion area 11 and program-listing area 12 are designed solely to save the user's time. The virtual channel 13 is not a physical channel, thus the name “virtual.” The viewer can set up the virtual channel to correspond to the desired programs of different channels. Therefore, the next time the viewer turns on the TV, he or she can switch the channel to the virtual channel, and all the desired programs he or she likes will be displayed. The problem of the viewer needing to remember the channel on which the desired programs are shown is thus resolved.

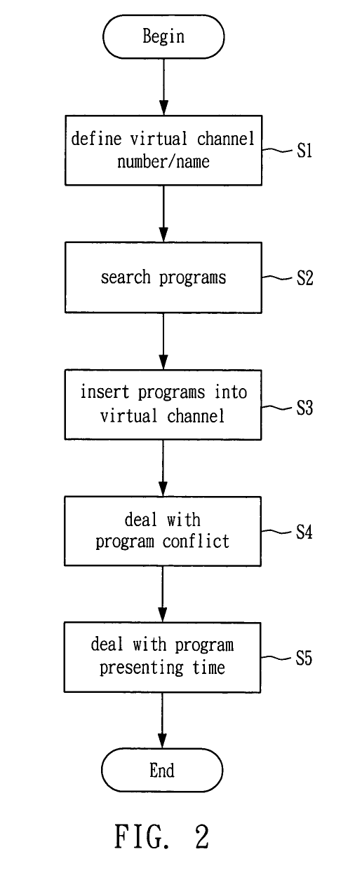

FIG. 2 shows a flow chart of defining virtual channels in an interactive program guide in accordance with an embodiment of the present invention. In step S1, the viewer defines virtual channel name and/or channel number so as to locate the virtual channels. In step S2, the present method proceeds to search programs in accordance with the user-defined criterion, and lists the programs satisfying the criterion. In step S3, the desired programs are selected and inserted into the virtual channel. In step S4, because the virtual channel likely has programs with conflicting schedules, the present method may have to resolve program conflict. In step S5, because the virtual channel likely has programs with display times different from those shown on the header, the present method may have to resolve such issues with the program display times, which has been illustrated in the embodiment shown in FIG. 1.

The above-described embodiments of the present invention are intended to be illustrative only. Numerous alternative embodiments may be devised by persons skilled in the art without departing from the scope of the following claims.

What is claimed is:

1. A method for defining virtual channels in an interactive program guide, comprising the steps of:
defining a virtual channel number and/or channel name;
inserting desired programs in an electronic program guide (EPG) into the defined virtual channel; and
resolving scheduling conflicts of the searched programs.

2. The method of claim 1, wherein the desired program is a searched program in the EPG which satisfies a search criterion.

3. The method of claim 2, wherein the searching step includes searching a category, classification and string in hierarchy.

4. The method of claim 2, wherein the inserting step includes moving the searched programs to the virtual channel with a mouse or remote controller.

5. The method of claim 1, further comprising the step of highlighting programs on the virtual channel that have conflicting schedules.

6. The method of claim 5, further comprising the step of recording one of the conflicting programs and displaying it at a later conflict-free time.

7. The method of claim 1, further comprising the step of popping up a warning message when a viewer is watching one program and another pre-defined program is going to display.

8. The method of claim 1, further comprising the step of resolving program display time.

9. The method of claim 8, further comprising the step of checking whether system resources are sufficient to record if the program display time is later than that shown in the schedule of a program header.

10. The method of claim 8, further comprising the step of checking whether the desired program exists in memory if the program display time is earlier than that shown in the schedule of a program header.

11. A method for providing a program guide, comprising the steps of:
defining a virtual channel;
selectively inserting programs, each corresponding to a time slot, into the defined virtual channel;
determining whether an overlap between the time slots of the programs exists; if yes, highlighting the overlap in the defined virtual channel; and
displaying the defined virtual channel.

12. The method of claim 11, further comprising the step of highlighting programs with conflicting schedules.

13. The method of claim 11, further comprising the step of searching programs in an EPG which satisfies a search criterion.

14. The method of claim 11, further comprising the step of checking whether system resources are sufficient to record if a program display time is later than that shown in the schedule of a program header.

15. A user interface for defining virtual channels in an interactive program guide, comprising:
a search criterion area including hierarchical searching items;
a program-listing area configured to list programs of the EPG which satisfy a search criterion of the search criterion area; and
a virtual channel collecting desired programs picked out from the program-listing area.

16. The user interface of claim 15, wherein the search criterion area includes category field, classification field and string field arranged in hierarchy.

17. The user interface of claim 16, wherein the category field includes sports, music, movie and news.

18. The user interface of claim 15, further comprising means for moving the desired programs selected from the program-listing area to the virtual channel.

19. The user interface of claim 15, wherein the program-listing area has a scrolling bar.

20. The user interface of claim 15, wherein the virtual channel displays different colors in programs whose schedules conflict with each other.
